(19) United States
(12) Patent Application Publication
(10) Pub. No.: US 2014/0222997 A1
(43) Pub. Date: Aug. 7, 2014

(54) HIDDEN MARKOV MODEL BASED ARCHITECTURE TO MONITOR NETWORK NODE ACTIVITIES AND PREDICT RELEVANT PERIODS

(71) Applicant: Cisco Technology, Inc., San Jose, CA (US)

(72) Inventors: Grégory Mermoud, Veyras (CH); Jean-Philippe Vasseur, Saint Martin d'Uriage (FR); Sukrit Dasgupta, Norwood, MA (US)

(21) Appl. No.: 13/955,648

(22) Filed: Jul. 31, 2013

Related U.S. Application Data
(60) Provisional application No. 61/761,134, filed on Feb. 5, 2013.

(51) Int. Cl. H04L 12/24; H04L 12/26

(52) U.S. Cl. CPC H04L 41/142; H04L 43/04
USPC 709/224

(57) ABSTRACT

In one embodiment, techniques are shown and described relating to a Hidden Markov Model based architecture to monitor network node activities and predict relevant periods. In particular, in one embodiment, a device determines a statistical model for each of one or more singular-node traffic profiles (e.g., based on one or more Hidden Markov Models (HMMs) each corresponding to a respective one of the one or more traffic profiles). By analyzing respective traffic from individual nodes in a computer network, and matching the respective traffic against the statistical model for the one or more traffic profiles, the device may detecting a matching traffic profile for the individual nodes in a computer network. In addition, the device may predict relevant periods of traffic for the individual nodes by extrapolating a most-likely future sequence based on prior respective traffic of the individual nodes and the corresponding matching traffic profile.

### RELATED APPLICATION

The present invention claims priority to U.S. Provisional Application Ser. No. 61/761,134, filed Feb. 5, 2013, entitled “A HIDDEN MARKOV MODEL BASED ARCHITECTURE TO MONITOR NETWORK NODE ACTIVITIES AND PREDICT RELEVANT PERIODS”, by Mermoud, et al., the contents of which are incorporated herein by reference.

### TECHNICAL FIELD

The present disclosure relates generally to computer networks, and, more particularly, to the use of learning machines within computer networks.

### BACKGROUND

Low power and Lossy Networks (LLNs), e.g., Internet of Things (IoT) networks, have a myriad of applications, such as sensor networks, Smart Grids, and Smart Cities. Various challenges are presented with LLNs, such as lossy links, low bandwidth, low quality transceivers, battery operation, low memory and/or processing capability, etc. The challenging nature of these networks is exacerbated by the large number of nodes (an order of magnitude larger than a “classic” IP network), thus making the routing, Quality of Service (QoS), security, network management, and traffic engineering extremely challenging, to mention a few.

Machine learning (ML) is concerned with the design and the development of algorithms that take as input empirical data (such as network statistics and states, and performance indicators), recognize complex patterns in these data, and solve complex problems such as regression (which are usually extremely hard to solve mathematically) thanks to modeling. In general, these patterns and computation of models are then used to make decisions automatically (i.e., close-loop control) or to help make decisions. ML is a very broad discipline used to tackle very different problems (e.g., computer vision, robotics, data mining, search engines, etc.), but the most common tasks are the following: linear and non-linear regression, classification, clustering, dimensionality reduction, anomaly detection, optimization, association rule learning.

One very common pattern among ML algorithms is the use of an underlying model M, whose parameters are optimized for minimizing the cost function associated to M, given the input data. For instance, in the context of classification, the model M may be a straight line that separates the data into two classes such that M=a*x+b*y+c and the cost function would be the number of misclassified points. The ML algorithm then consists in adjusting the parameters a,b,c such that the number of misclassified points is minimal. After this optimization phase (or learning phase), the model M can be used very easily to classify new data points. Often, M is a statistical model, and the cost is function is inversely proportional to the likelihood of M, given the input data. Note that the example above is an over-simplification of more complicated regression problems that are usually highly multi-dimensional.

Learning Machines (LMs) are computational entities that rely on one or more ML algorithm for performing a task for which they haven't been explicitly programmed to perform. In particular, LMs are capable of adjusting their behavior to their environment (that is, “auto-adapting” without requiring a priori configuring static rules). In the context of LLNs, and more generally in the context of the IoT (or Internet of Everything, IoE), this ability will be very important, as the network will face changing conditions and requirements, and the network will become too large for efficiently management by a network operator. In addition, LLNs in general may significantly differ according to their intended use and deployed environment.

Thus far, LMs have not generally been used in LLNs, despite the overall level of complexity of LLNs, where “classic” approaches (based on known algorithms) are inefficient or when the amount of data cannot be processed by a human to predict network behavior considering the number of parameters to be taken into account.

### BRIEF DESCRIPTION OF THE DRAWINGS

The embodiments herein may be better understood by referring to the following description in conjunction with the accompanying drawings in which like reference numerals indicate identically or functionally similar elements, of which:

FIG. 1 illustrates an example communication network;

FIG. 2 illustrates an example network device/node;

FIG. 3 illustrates an example directed acyclic graph (DAG) in the communication network of FIG. 1;

FIG. 4 illustrates an example Bayesian network;

FIG. 5 illustrates an example signaling graph;

FIG. 6 illustrates an example Hidden Markov Model (HMM) represented by a Bayesian network;

FIG. 7 illustrates an example of “binning” of a traffic profile;

FIG. 8 illustrates and example HMM-based architecture;

FIG. 9 illustrates an example prediction of “relevant” periods; and

FIGS. 10-11 illustrate example simplified procedures for a Hidden Markov Model based architecture to monitor network node activities and predict relevant periods in accordance with one or more embodiments described herein.

### DESCRIPTION OF EXAMPLE EMBODIMENTS

### Overview

According to one or more embodiments of the disclosure, techniques are shown and described relating to a Hidden Markov Model based architecture to monitor network node activities and predict relevant periods. In particular, in one embodiment, a device determines a statistical model for each of one or more singular-node traffic profiles (e.g., based on one or more Hidden Markov Models (HMMs) each corresponding to a respective one of the one or more traffic profiles). By analyzing respective traffic from individual nodes in a computer network, and matching the respective traffic against the statistical model for the one or more traffic profiles, the device may detecting a matching traffic profile for the individual nodes in a computer network. In addition, the device may predict relevant periods of traffic for the individual nodes by extrapolating a most-likely future sequence based on prior respective traffic of the individual nodes and the corresponding matching traffic profile.

### DESCRIPTION

A computer network is a geographically distributed collection of nodes interconnected by communication links and segments for transporting data between end nodes, such as personal computers and workstations, or other devices, such as sensors, etc. Many types of networks are available, ranging from local area networks (LANs) to is wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, or Powerline Communications (PLC) such as IEEE 61334, IEEE P1901.2, and others. In addition, a Mobile Ad-Hoc Network (MANET) is a kind of wireless ad-hoc network, which is generally considered a self-configuring network of mobile routers (and associated hosts) connected by wireless links, the union of which forms an arbitrary topology.

Smart object networks, such as sensor networks, in particular, are a specific type of network having spatially distributed autonomous devices such as sensors, actuators, etc., that cooperatively monitor physical or environmental conditions at different locations, such as, e.g., energy/power consumption, resource consumption (e.g., water/gas/etc. for advanced metering infrastructure or “AMI” applications) temperature, pressure, vibration, sound, radiation, motion, pollutants, etc. Other types of smart objects include actuators, e.g., responsible for turning on/off an engine or perform any other actions. Sensor networks, a type of smart object network, are typically shared-media networks, such as wireless or PLC networks. That is, in addition to one or more sensors, each sensor device (node) in a sensor network may generally be equipped with a radio transceiver or other communication port such as PLC, a microcontroller, and an energy source, such as a battery. Often, smart object networks are considered field area networks (FANs), neighborhood area networks (NANs), personal area networks (PANs), etc. Generally, size and cost constraints on smart object nodes (e.g., sensors) result in corresponding constraints on resources such as energy, memory, computational speed and bandwidth.

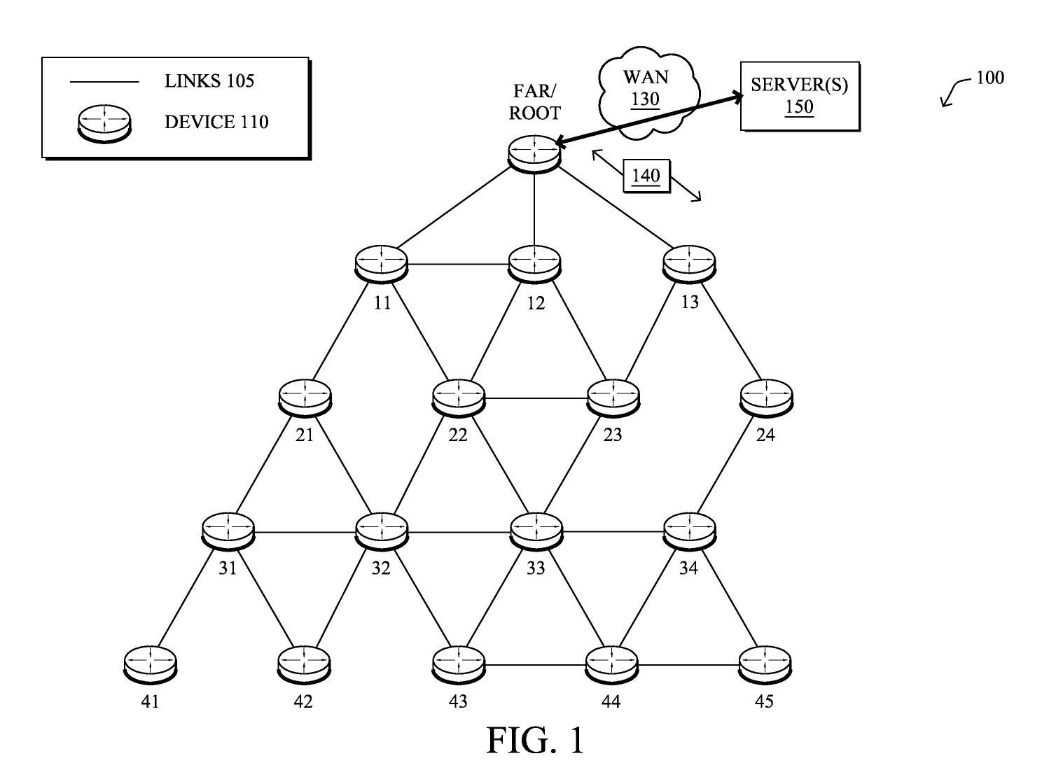

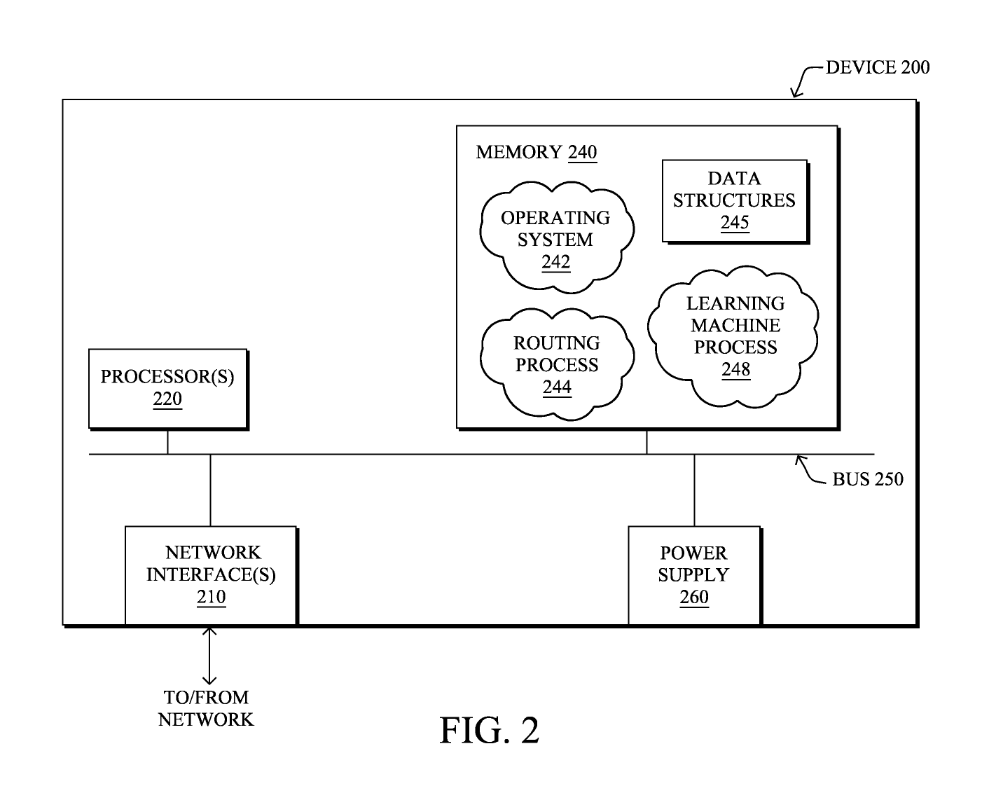

FIG. 1 is a schematic block diagram of an example computer network 100 illustratively comprising nodes/devices 110 (e.g., labeled as shown, “root,” “11,” “12,” . . . “45,” and described in FIG. 2 below) interconnected by various methods of communication. For instance, the links 105 may be wired links or shared media (e.g., wireless links, PLC links, etc.) where certain nodes 110, such as, e.g., routers, sensors, computers, etc., may be in communication with other nodes 110, e.g., based on distance, signal strength, current operational status, location, etc. The illustrative root node, such as a field area router (FAR) of a FAN, may interconnect the local network with a WAN 130, which may house one or more other relevant devices such as management devices or servers 150, e.g., a network management server (NMS), a dynamic host configuration protocol (DHCP) server, a constrained application protocol (CoAP) server, etc. Those skilled in the art will understand that any number of nodes, devices, links, etc. may be used in the computer network, and that the view shown herein is for simplicity. Also, those skilled in the art will further understand that while the network is shown in a certain orientation, particularly with a “root” node, the network 100 is merely an example illustration that is not meant to limit the disclosure.

Data packets 140 (e.g., traffic and/or messages) may be exchanged among the nodes/devices of the computer network 100 using predefined network communication protocols such as certain known wired protocols, wireless protocols (e.g., IEEE Std. 802.15.4, WiFi, Bluetooth®, etc.), PLC protocols, or other shared-media protocols where appropriate. In this context, a protocol consists of a set of rules defining how the nodes interact with each other.

FIG. 2 is a schematic block diagram of an example node/device 200 that may be used with one or more embodiments described herein, e.g., as any of the nodes or devices shown in FIG. 1 above. The device may comprise one or more network interfaces 210 (e.g., wired, wireless, PLC, etc.), at least one processor 220, and a memory 240 interconnected by a system bus 250, as well as a power supply 260 (e.g., battery, plug-in, etc.).

The network interface(s) 210 contain the mechanical, electrical, and signaling circuitry for communicating data over links 105 coupled to the network 100. The network interfaces may be configured to transmit and/or receive data using a variety of different communication protocols. Note, further, that the nodes may have two different types of network connections 210, e.g., wireless and wired/physical connections, and that is the view herein is merely for illustration. Also, while the network interface 210 is shown separately from power supply 260, for PLC (where the PLC signal may be coupled to the power line feeding into the power supply) the network interface 210 may communicate through the power supply 260, or may be an integral component of the power supply.

The memory 240 comprises a plurality of storage locations that are addressable by the processor 220 and the network interfaces 210 for storing software programs and data structures associated with the embodiments described herein. Note that certain devices may have limited memory or no memory (e.g., no memory for storage other than for programs/processes operating on the device and associated caches). The processor 220 may comprise hardware elements or hardware logic adapted to execute the software programs and manipulate the data structures 245. An operating system 242, portions of which are typically resident in memory 240 and executed by the processor, functionally organizes the device by, inter alia, invoking operations in support of software processes and/or services executing on the device. These software processes and/or services may comprise a routing process/services 244 and an illustrative “learning machine” process 248, which may be configured depending upon the particular node/device within the network 100 with functionality ranging from intelligent learning machine algorithms to merely communicating with intelligent learning machines, as described herein. Note also that while the learning machine process 248 is shown in centralized memory 240, alternative embodiments provide for the process to be specifically operated within the network interfaces 210.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while the processes have been shown separately, those skilled in the art will appreciate that processes may be routines or modules within other processes.

Routing process (services) 244 contains computer executable instructions executed by the processor 220 to perform functions provided by one or more routing protocols, such as proactive or reactive routing protocols as will be understood by those skilled in the art. These functions may, on capable devices, be configured to manage a routing/forwarding table (a data structure 245) containing, e.g., data used to make routing/forwarding decisions. In particular, in proactive routing, connectivity is discovered and known prior to computing routes to any destination in the network, e.g., link state routing such as Open Shortest Path First (OSPF), or Intermediate-System-to-Intermediate-System (ISIS), or Optimized Link State Routing (OLSR). Reactive routing, on the other hand, discovers neighbors (i.e., does not have an a priori knowledge of network topology), and in response to a needed route to a destination, sends a route request into the network to determine which neighboring node may be used to reach the desired destination. Example reactive routing protocols may comprise Ad-hoc On-demand Distance Vector (AODV), Dynamic Source Routing (DSR), DYnamic MANET On-demand Routing (DYMO), etc. Notably, on devices not capable or configured to store routing entries, routing process 244 may consist solely of providing mechanisms necessary for source routing techniques. That is, for source routing, other devices in the network can tell the less capable devices exactly where to send the packets, and the less capable devices simply forward the packets as directed.

Notably, mesh networks have become increasingly popular and practical in recent years. In particular, shared-media mesh networks, such as wireless or PLC networks, etc., are often on what is referred to as Low-Power and Lossy Networks (LLNs), which are a class of network in which both the routers and their interconnect are constrained: LLN routers typically operate with constraints, e.g., processing power, memory, and/or energy (battery), and their interconnects are characterized by, illustratively, high loss rates, low data rates, and/or instability. LLNs are comprised of anything from a few dozen and up to thousands or even millions of LLN routers, and support point-to-point traffic (between devices inside the LLN), point-to-multipoint traffic (from a central control point such at the root node to a subset of devices inside the LLN) and multipoint-to-point traffic (from devices inside the LLN towards a central control point).

An example implementation of LLNs is an “Internet of Things” network. Loosely, the term “Internet of Things” or “IoT” (or “Internet of Everything” or “IoE”) may be used by those in the art to refer to uniquely identifiable objects (things) and their virtual representations in a network-based architecture. In particular, the next frontier in the evolution of the Internet is the ability to connect more than just computers and communications devices, but rather the ability to connect “objects” in general, such as lights, appliances, vehicles, HVAC (heating, ventilating, and air-conditioning), windows and window shades and blinds, doors, locks, etc. The “Internet of Things” thus generally refers to the interconnection of objects (e.g., smart objects), such as sensors and actuators, over a computer network (e.g., IP), which may be the Public Internet or a private network. Such devices have been used in the industry for decades, usually in the form of non-IP or proprietary protocols that are connected to IP networks by way of protocol translation gateways. With the emergence of a myriad of applications, such as the smart grid, smart cities, and building and industrial automation, and cars (e.g., that can interconnect millions of objects for sensing things like power quality, tire pressure, and temperature and that can actuate engines and lights), it has been of the utmost importance to extend the IP protocol suite for these networks.

An example protocol specified in an Internet Engineering Task Force (IETF) Proposed Standard, Request for Comment (RFC) 6550, entitled “RPL: IPv6 Routing Protocol for Low Power and Lossy Networks” by Winter, et al. (March 2012), provides a mechanism that supports multipoint-to-point (MP2P) traffic from devices inside the LLN towards a central control point (e.g., LLN Border Routers (LBRs), FARs, or “root nodes/devices” generally), as well as point-to-multipoint (P2MP) traffic from the central control point to the devices inside the LLN (and also point-to-point, or “P2P” traffic). RPL (pronounced “ripple”) may generally be described as a distance vector routing protocol that builds a Directed Acyclic Graph (DAG) for use in routing traffic/packets 140, in addition to defining a set of features to bound the control traffic, support repair, etc. Notably, as may be appreciated by those skilled in the art, RPL also supports the concept of Multi-Topology-Routing (MTR), whereby multiple DAGs can be built to carry traffic according to individual requirements.

Also, a directed acyclic graph (DAG) is a directed graph having the property that all edges are oriented in such a way that no cycles (loops) are supposed to exist. All edges are contained in paths oriented toward and terminating at one or more root nodes (e.g., “clusterheads or “sinks”), often to interconnect the devices of the DAG with a larger infrastructure, such as the Internet, a wide area network, or other domain. In addition, a Destination Oriented DAG (DODAG) is a DAG rooted at a single destination, i.e., at a single DAG root with no outgoing edges. A “parent” of a particular node within a DAG is an immediate successor of the particular node on a path towards the DAG root, such that the parent has a lower “rank” than the particular node itself, where the rank of a node identifies the node's position with respect to a DAG root (e.g., the farther away a node is from a root, the higher is the rank of that node). Note also that a tree is a kind of DAG, where each device/node in the DAG generally has one parent or one preferred parent. DAGs may generally be built (e.g., by a DAG process and/or routing process 244) based on an Objective Function (OF). The role of the Objective Function is generally to specify rules on how to build the DAG (e.g. number of parents, backup parents, etc.).

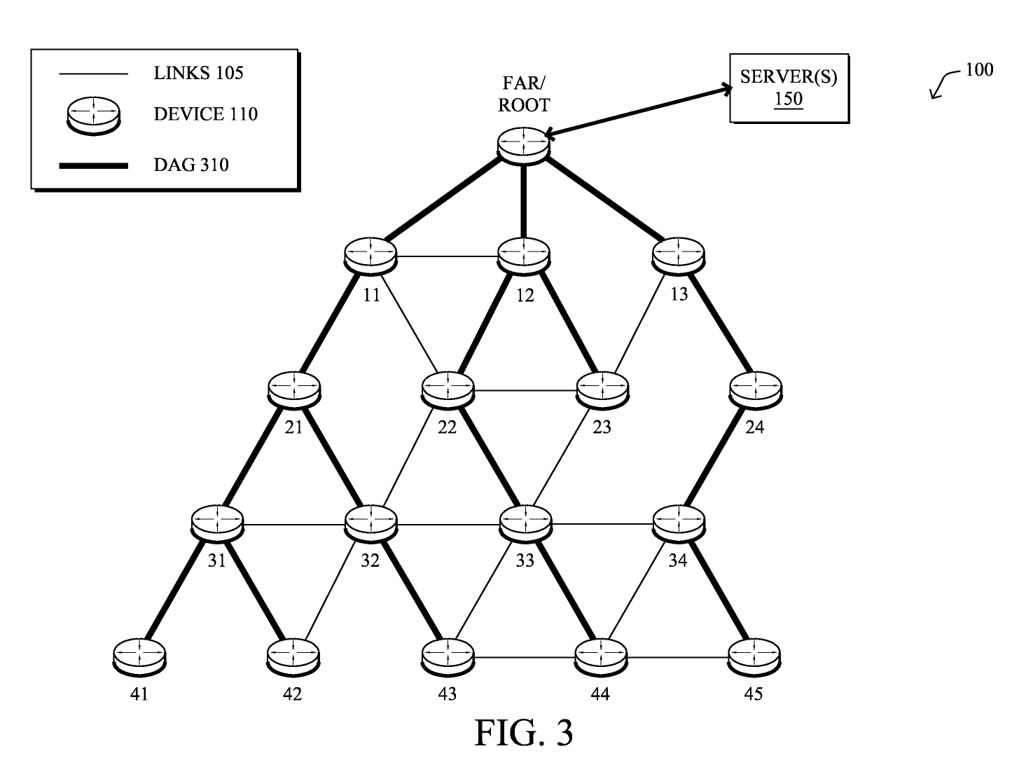

FIG. 3 illustrates an example simplified DAG that may be created, e.g., through the techniques described above, within network 100 of FIG. 1. For instance, certain links 105 may be selected for each node to communicate with a particular parent (and thus, in the reverse, to communicate with a child, if one exists). These selected links form the DAG 310 (shown as bolded lines), which extends from the root node toward one or more leaf nodes (nodes without children). Traffic/packets 140 (shown in FIG. 1) may then traverse the DAG 310 in either the upward direction toward the root or downward toward the leaf nodes, particularly as described herein.

Learning Machine Technique(s)

As noted above, machine learning (ML) is concerned with the design and the development of algorithms that take as input empirical data (such as network statistics and state, and performance indicators), recognize complex patterns in these data, and is solve complex problem such as regression thanks to modeling. One very common pattern among ML algorithms is the use of an underlying model M, whose parameters are optimized for minimizing the cost function associated to M, given the input data. For instance, in the context of classification, the model M may be a straight line that separates the data into two classes such that M=a*x+b*y+c and the cost function would be the number of misclassified points. The ML algorithm then consists in adjusting the parameters a,b,c such that the number of misclassified points is minimal. After this optimization phase (or learning phase), the model M can be used very easily to classify new data points. Often, M is a statistical model, and the cost function is inversely proportional to the likelihood of M, given the input data.

As also noted above, learning machines (LMs) are computational entities that rely one or more ML algorithm for performing a task for which they haven't been explicitly programmed to perform. In particular, LMs are capable of adjusting their behavior to their environment. In the context of LLNs, and more generally in the context of the IoT (or Internet of Everything, IoE), this ability will be very important, as the network will face changing conditions and requirements, and the network will become too large for efficiently management by a network operator. Thus far, LMs have not generally been used in LLNs, despite the overall level of complexity of LLNs, where “classic” approaches (based on known algorithms) are inefficient or when the amount of data cannot be processed by a human to predict network behavior considering the number of parameters to be taken into account.

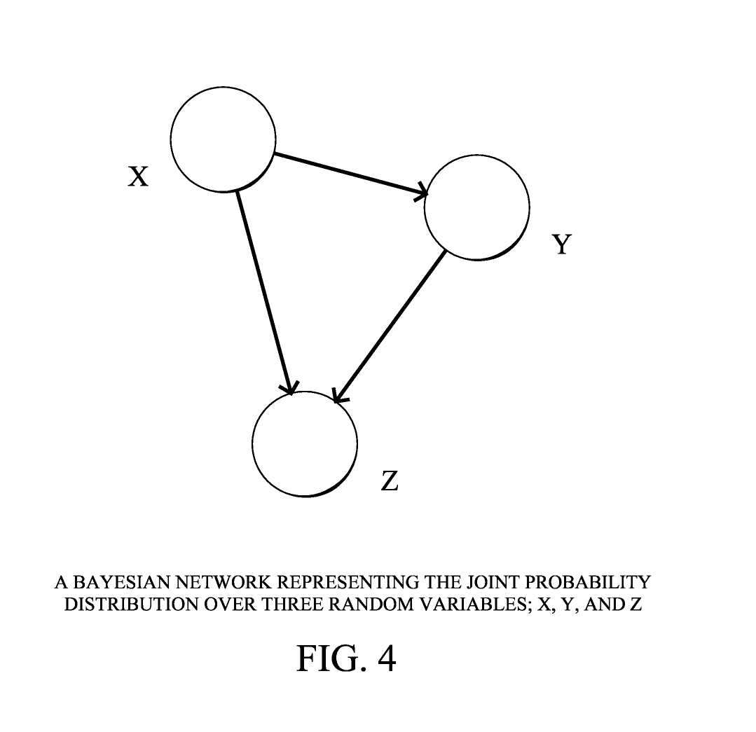

In particular, many LMs can be expressed in the form of a probabilistic graphical model also called Bayesian Network (BN). A BN is a graph G=(V,E) where V is the set of vertices and E is the set of edges. The vertices are random variables, e.g., X, Y, and Z (see FIG. 4) whose joint distribution P(X,Y,Z) is given by a product of conditional probabilities:

P(X,Y,Z)=P(Z|X,Y)P(Y|X)P(X) (Eq. 1)

The conditional probabilities in Eq. 1 are given by the edges of the graph in FIG. 4. In the context of LMs, BNs are used to construct the model M as well as its parameters.

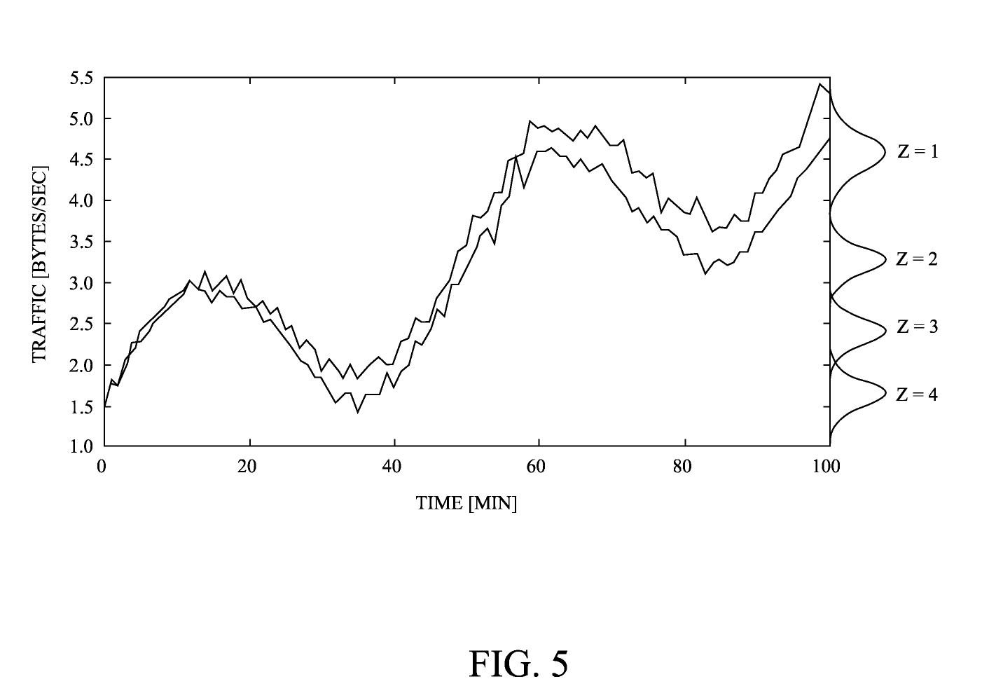

For instance, a common example of an ML algorithm that can be into a BN is the Hidden Markov Model (HMM). The HMM is essentially a probabilistic model of sequential data. To illustrate how an HMM works, the following example with reference to FIG. 5 is given:

Each signal shown in FIG. 5 can be represented as a sequence of values x₁, x₂, . . . , x_{N}, with N=100 (each value xⱼ represents the average traffic in bytes/sec averaged over 1 minute). In an HMM, each value xᵢ is modeled as a random variable whose probability density function depends on an underlying,—hidden state—zᵢ that may take discrete values between 1 and K. In this example, K=4, and each of these states corresponds to a different traffic setting: z=1 corresponds to large traffic settings of 4 bytes per second and more whereas z=4 corresponds to small traffic settings. As a result, an HMM does not capture explicitly the dependence between xᵢ₋₁ and xᵢ; instead, it uses a Markov chain to model the sequence z₁, z₂, . . . , z_{N}.

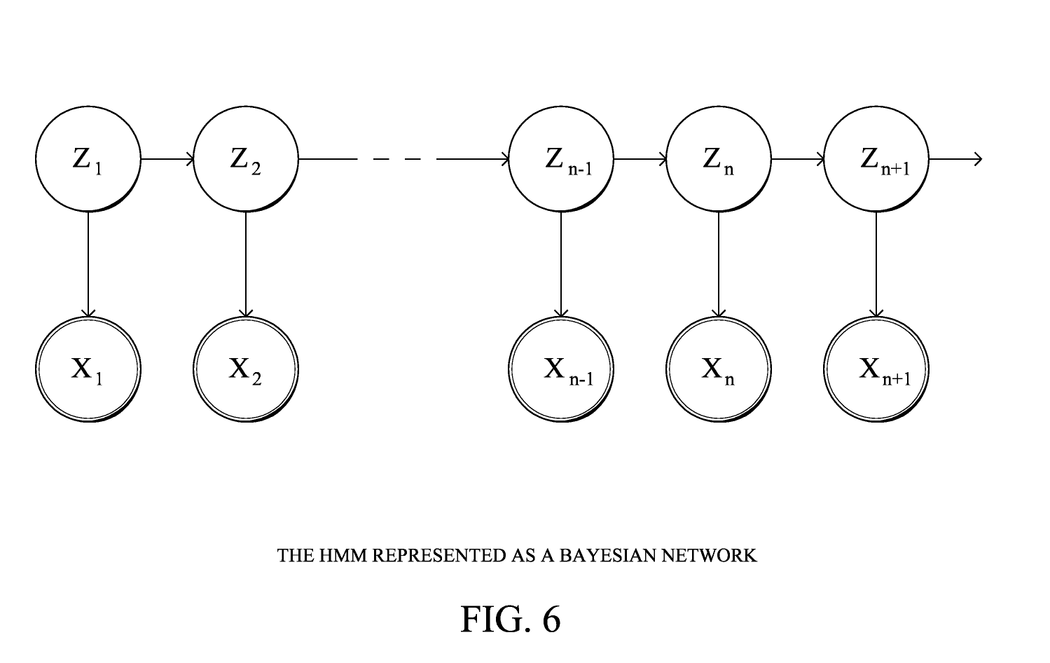

In other words, the probability distribution of zₙ₋₁ depends on and is given by a K×K transition matrix A=(Aᵢⱼ) where Aᵢⱼ=P(zₙ=j|zₙ₋₁=i). The model assumes that the observed data are random variables X, whose distribution depends on the underlying state zᵢ and is called an emission probability. As a result, an HMM can be represented by the BN shown in FIG. 6.

Importantly, the states zᵢ cannot be observed, which is why they are called hidden states. Instead, their value can be inferred from empirical data. The parameters of the HMM (i.e., the number of hidden states, the transition matrix A and the emission probabilities) may either be explicitly defined according to prior knowledge of the system, or they can be learned from empirical data. The latter usage is more typical, and is generally achieved by estimating and maximizing the likelihood of the HMM with respect to existing data (called the learning data set). If a learning data set x={x₁, . . . , x_{N}}, the likelihood function is given by:

p(x|θ)=Σ_{z}p(x,z|θ)

where θ represents the parameters of the HMM. One of the key challenge in maximizing this likelihood function is that the state variables zᵢ are unknown. As a result, one needs to perform the summation over all K possible values of zᵢ for i=1, N, which results in K^{N} terms. This approach becomes rapidly intractable as both K and N grows; instead, one can use the expectation maximization (EM) algorithm to solve this problem. In other words, the EM algorithm adopts an iterative approach in which two successive steps are applied until convergence. The E-step estimates the expected value of the likelihood function with respect to the conditional distribution of Z given X, under the current estimate of the parameters θ^{(t)}:

Q(θ|θ^{(t)})=E_{z|x,θ(t)}[p(x,z|θ]

Computing this quantity no longer requires performing the summation over all values of all variables of Z. The M-step then maximizes this function:

θ^{(t+1)}=arg max_{θ}Q(θ|θ^{(t)})

where arg maxₓ f(x) returns the parameter x that maximizes f(x).

Now, it can be shown that the sequence θ⁽⁰⁾, θ⁽¹⁾, θ⁽²⁾, . . . converges to some local minimum of the likelihood function. As a result, the EM algorithm must generally be executed multiple times with different initial conditions.

In the example shown in FIG. 5, one would train the HMM based on data of type A (lower values). The EM algorithm would adjust both the mean and the variance of the Gaussian distributions that describe the emission probabilities for zᵢ=k with k=1, . . . , 4 in such a way that the whole spectrum of values found in the input data is covered in some statistically optimal way. In parallel, the algorithm will generate a transition rates Aₖₗ describing the transition from one state zᵢ₋₁=k to the next zᵢ=1 such that the input sequence could have likely been generated by this Markov chain.

Together with BNs, the EM algorithm is one central piece of the mathematical framework used for designing and implementing LMs. By modifying the structure of the BN and updating the EM algorithm accordingly, one can obtain LMs with very different features and capabilities, as well as very different computational costs. BNs and HMMs is are generally known learning machine algorithms, and the specifics described herein are merely examples for illustration.

Notably, many routine tasks in LLNs need to be executed only in suitable traffic conditions. For instance, when one is interested in monitoring the QoS of a given node, the probes need to be sent at times where the traffic is representative of a normal activity. In other scenarios, one is interested in predicting quiet periods for carrying out maintenance tasks or start gathering network management data for example since the LM has predicted that there will be a quiet period that can advantageously be used to carry control plane traffic (e.g., firmware update, shadow joining, reboots, etc.).

The techniques herein rely on an HMM-based architecture to analyze various traffic flows (user traffic, control plane, etc.) so as to detect and classify node activities (e.g., firmware upgrade, WPAN joining, meter reading, various applications, etc.) and predict so-called “relevant” periods, that is, time intervals that are of particular interest for a given task. The NMS may subscribe to notifications about node activities from the FAR, and it may delegate tasks to the FAR, which the latter will execute only during “relevant” periods.

However, determining the “relevance” of a given traffic pattern is difficult using a classic algorithm, as it does not account for the intrinsic randomness and unpredictability of LLNs, and it often relies on a deterministic model of the traffic (e.g., threshold-based approaches) or pure Markov-chain models (which are not applicable to LLNs) that requires careful and delicate parameter tuning. Also, these algorithms typically exhibit abrupt performance degradation in case of abnormal conditions of operation. Most of the current approaches are ill-suited to LLNs and, thus the techniques herein propose a Learning Machine based technology for quiet/relevant period prediction.

Specifically, the techniques herein utilize a probabilistic framework for modeling traffic patterns, thereby accounting for the randomness and unpredictability of LLNs. By inferring the model parameters from previous data, there is no need for a priori manual parameter tuning. Last, since the model is intrinsically probabilistic, it is able to deal with changing conditions of operation, first by exhibiting a graceful degradation of its performance, and then by adjusting its parameters dynamically in order to recover its nominal performance.

Said differently, the techniques herein specify an HMM-based architecture for endowing the FAR with two new capabilities: (1) detecting node activities based on input traffic data by matching the latter against known traffic profiles (e.g., firmware upgrade, meter readings, WPAN joining, applications), and (2) predicting periods that correspond to traffic conditions that are relevant to specific tasks. A first component of the techniques herein lies in the ability of the FAR to notify the NMS or other nodes in the network performing specific actions (e.g., a head-end) about nodes' activities, including scenarios in which nodes are generating traffic that cannot be recognized, and could therefore indicate a bug in the firmware of the nodes or an attack. This component is therefore an essential building block of enhanced security and troubleshooting in LLNs. A second component of the techniques herein is the ability of specific task handlers to query the LM for predictions about relevant periods in terms of traffic conditions. Using this mechanism, these task handlers can execute a given tasks in optimal traffic conditions. To this end, the techniques herein introduce a new message sent by the task handler to the FAR that specifies the specific traffic and timing requirements that the task of interest is requiring. In this described architecture, traffic (samples) are sent to a LM that trains HMM. Once trained, HMMs are used for prediction and use request coming from task handler to provide prediction of relevant periods to perform their task.

Illustratively, the techniques described herein may be performed by hardware, software, and/or firmware, such as in accordance with the learning machine process 248, which may contain computer executable instructions executed by the processor 220 (or independent processor of interfaces 210) to perform functions relating to the techniques described herein, e.g., optionally in conjunction with other processes. For example, certain aspects of the techniques herein may be treated as extensions to conventional protocols, such as the various communication protocols (e.g., routing process 244), and as such, may be processed by similar components understood in the art that execute those protocols, accordingly. Also, while certain aspects of the techniques herein may be described from the perspective of a single node/device, embodiments described herein may be performed as distributed intelligence, also referred to as edge/distributed computing, such as hosting intelligence within nodes 110 of a Field Area Network in addition to or as an alternative to hosting intelligence within servers 150.

Notably, the techniques herein use the well-known Hidden Markov Model (HMM) to model the traffic patterns. HMM-based LMs have been very successful in problems such as speech recognition or genetic sequencing. For each pattern of interest, an HMM is trained using the Expectation Maximization algorithm, i.e., the parameters of the model are adjusted in such a way that its likelihood given the training data is maximized. Once properly trained, the HMM can be used to solve three distinct types of problems:

*One can see an HMM as a mathematical function that takes a traffic pattern as input, and yields its “likelihood”, i.e., the probability that it belongs to the class modeled by the HMM. For instance, in FIG. 5, the HMM has been trained for sequences of type A (lower values), with an average log-likelihood of −25.83. When sequences of type B (upper values) are passed as input to the trained HMM, one obtains an average log-likelihood of −53.16 (that is, 12 orders of magnitude). This example illustrates clearly the very powerful ability of HMMs to recognize and match patterns even in presence of noise. In the context of connected energy networks, assume that one has trained two HMMs M₁ and M₂: M₁ has been trained using traffic generated by the smart metering application, and M₂ using traffic generated by meter authentications. Then, if one constantly feeds the traffic into both M₁ and M₂, one may expect a spike in the probability outputted by M₁ whenever a meter reading occurs.

*An HMM has some predictive capabilities, i.e., it is capable of completing a partial input with probable endings. More specifically, given the first items x₁, x₂, x₃ of a time series that compose a given traffic pattern x₁, . . . , xₙ, an HMM is able to generate realizations of the stochastic process: x₄, x₅, . . . , xₙ. A stochastic process is a collection of random variables xᵢ, x₂, . . . , xₙ that represent the time evolution of a system. An example is of stochastic process is a sequence of dice rolls where each trial is represented by a random variable xᵢ that may take integer value between 1 and 6. As a matter of fact, any quantity that varies over time with some degree of randomness can be, in principle, modeled as a stochastic process. A realization of the stochastic process x₁, x₂, . . . , xₙ as mentioned above is a sequence of actual values of these variables (i.e., the actual outcome of a dice roll). In the context of the techniques herein, the traffic patterns can be seen as stochastic processes, and an HMM is a unified model of these processes, which can be used both for recognizing and classifying them, but also for generating realizations of these processes.

*Given an input sequence x₁, . . . , xₙ, one can use an HMM to determine the most likely sequence of hidden states z₁, . . . , zₙ. When the latter are meaningful to the user, this information can be very important (e.g., in speech recognition, they may correspond to phonemes, while the observed variables are typically multi-dimensional vectors yielded by the Fourier transform of the signal). In the techniques herein, the hidden states have no specific meaning, but they may be used a lower-dimensional representation of the input sequence (recall that xᵢ are multi-dimensional input vectors, whereas zᵢ are scalars). In the example of FIG. 5, the “z” values indicate the most likely sequence of hidden states for the input traffic pattern of type A; when associating meaningful labels to these states (such as, z=1 is low traffic, z=2 is normal traffic, z=3 is maximal traffic, z=4 is abnormal traffic), one may use HMMs to convert continuous traffic patterns into qualitative sequences of network states. Keep in mind that the description herein uses an over-simplified example for the sake of illustration, but real-world HMMs exhibit much more powerful capabilities for interpretation, and in particular they are capable of discriminating between two different hidden states that share the same “spectrum” of output value by accounting for the previous state. For instance, in a more complicated example, a traffic of 5 bytes/sec may be alternatively labeled as normal or abnormal depending on the value of another dimension (e.g., the rate of ICMPv6 messages) or the historical evolution of the traffic itself.

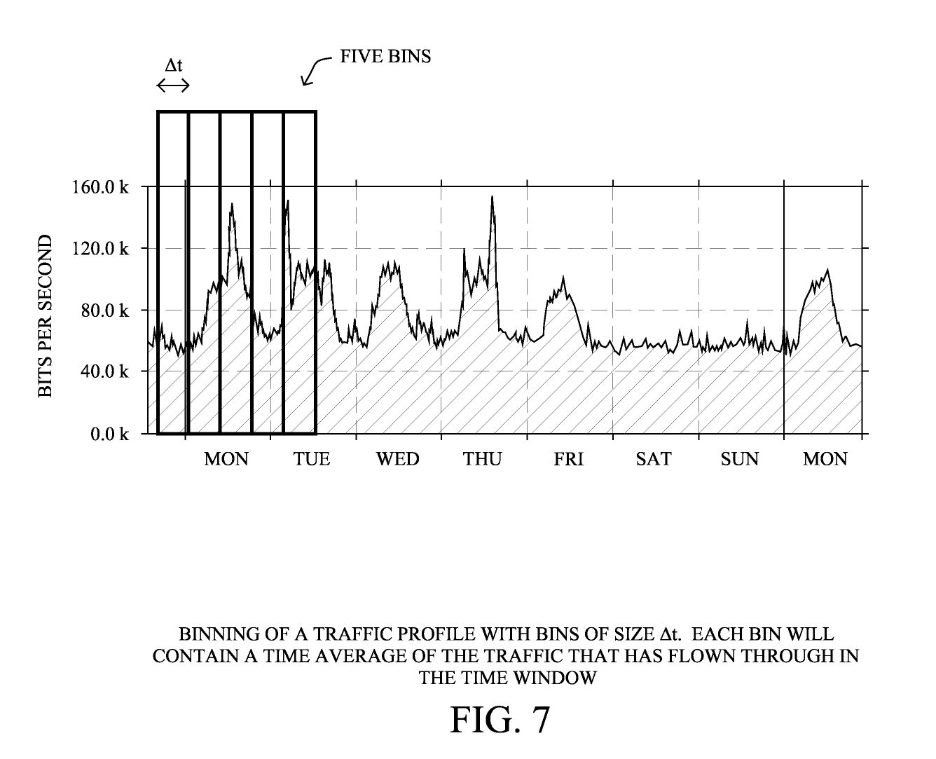

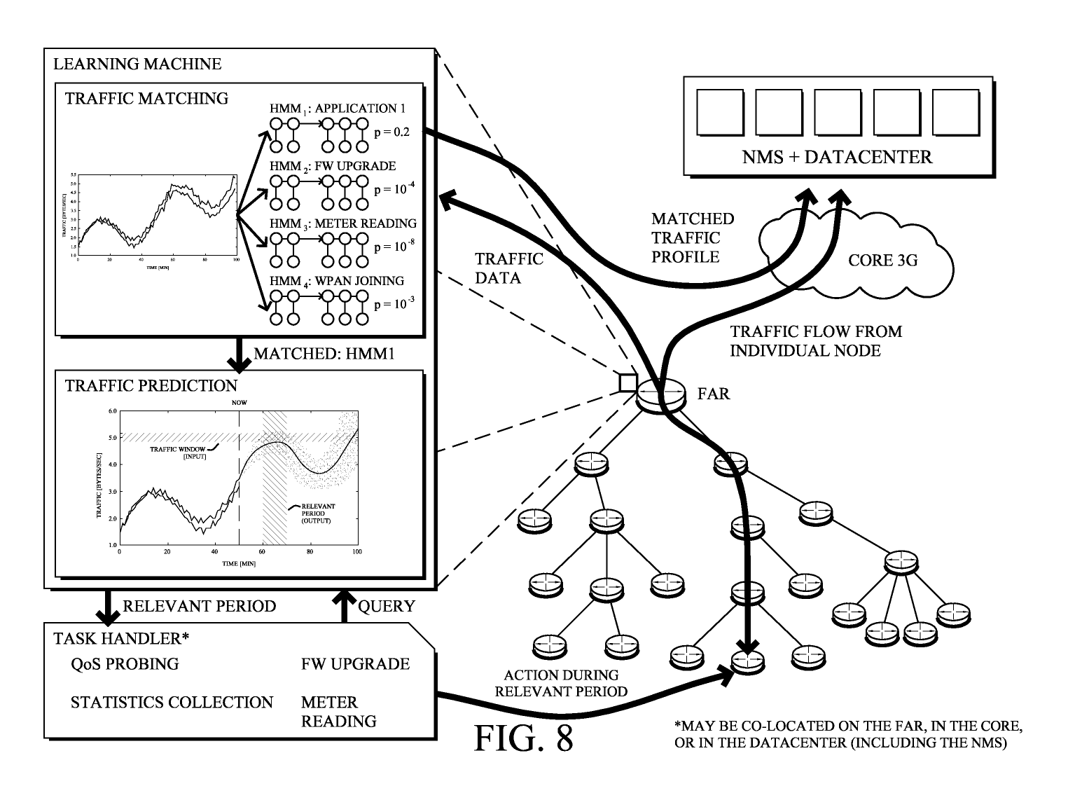

Operationally, the first component of the techniques herein is an HMM-based architecture (see FIG. 8) for analyzing the traffic of every node in the network. In particular, the techniques herein assume that a unique HMM is sufficient for capturing one particular class of traffic for every node in the network. In another embodiment, one may try to cluster the nodes according to their traffic profiles, thereby adjusting the number of HMMs. This approach might be needed when the heterogeneity of the network is such that similar underlying tasks (e.g., firmware upgrade, meter reading, etc.) lead to very different traffic profiles. However, the advantage of the single-HMM approach is the availability of more data during the training phase. The critical point to bear in mind, and which is different from current techniques, is that the techniques herein construct a statistical model (under the form of a series of HMMs) of the traffic profiles exhibited by a single node, and not the aggregated traffic of the whole network. This architecture allows the techniques herein to perform both detection (also called matching hereafter) and prediction for each node in the network. This approach is especially useful as networks become more heterogeneous and different nodes cater to different kinds of applications, which will in turn lead to more disparate traffic profiles. To this end, the techniques herein define the observed variables xᵢ as multi-dimensional traffic data (each dimension corresponds to a different type of traffic, and they are given in bit/s) averaged on a time interval [tᵢ,tᵢ+Δt] (called a bin, see FIG. 7). The techniques herein also consider various granularities of traffic type (e.g., user vs. control plane traffic, differentiations based on message types such as CoAP, ICMP, RPL messages, Differentiated Services Code Point (DSCP) values or even more fine-grained distinctions based on port destination, etc.) The width Δt of these bins will depend on the pattern of interest, and may range between a few tens of milliseconds to an hour. Given a set of training data {x₁, x₂, . . . } with xᵢ=[x_{i,1}, x_{i,2}, . . . ], one can use the Expectation-Maximization algorithm to learn the parameters of a given HMM (i.e., the transition matrix A and the emission probabilities for each state 1 to K).

Note that traffic samples (bin) may be passed locally between the FAR and the LM if they are located using for example a TCP socket, or via a newly defined IPv6 message should the LM not be located with the FAR.

A second component of the techniques herein is an LM that analyzes the traffic of each node in the network and matches it against different traffic profiles corresponding to is different underlying node activities. This component utilizes a batch of HMMs M₁, M₂, . . . , M_{N}; each of them is trained to recognize one specific traffic profile. In the context of the techniques herein, it may be assumed that there is a sufficiently large dataset of traffic patterns labeled by an expert, generally in an offline manner, prior to the training process. Each HMM may use a different binning as a function of the traffic profile to be recognized: indeed, the time-scales of interest may vary as a function of the profile of interest. Once the training is performed, all traffic data are passed as input of the HMMs in order to recognize traffic patterns. For any input sequence x=[x₁, x₂, . . . ], the probability P(x|Mᵢ) of this sequence given each HMM Mᵢ is evaluated: if P(x|Mᵢ) is larger than a given threshold T_{match}, it indicates the traffic profile corresponding to x. If no HMM is being sufficiently activated, it means that the traffic pattern is unknown. This is a particularly useful concept as the LM can now monitor traffic on a per node basis, and transmit the matched traffic profiles to the NMS, which may then assert that they are consistent with the expected activity of the node. This has far reaching consequences of allowing an operator to narrow down various issues to a per-node level. Such a mechanism is much needed as LLNs start to grow and sophisticated mechanisms to troubleshoot will be required. In particular, in terms of security, detection of previously unknown traffic profiles may indicate an attack on the network, or a bug in the firmware.

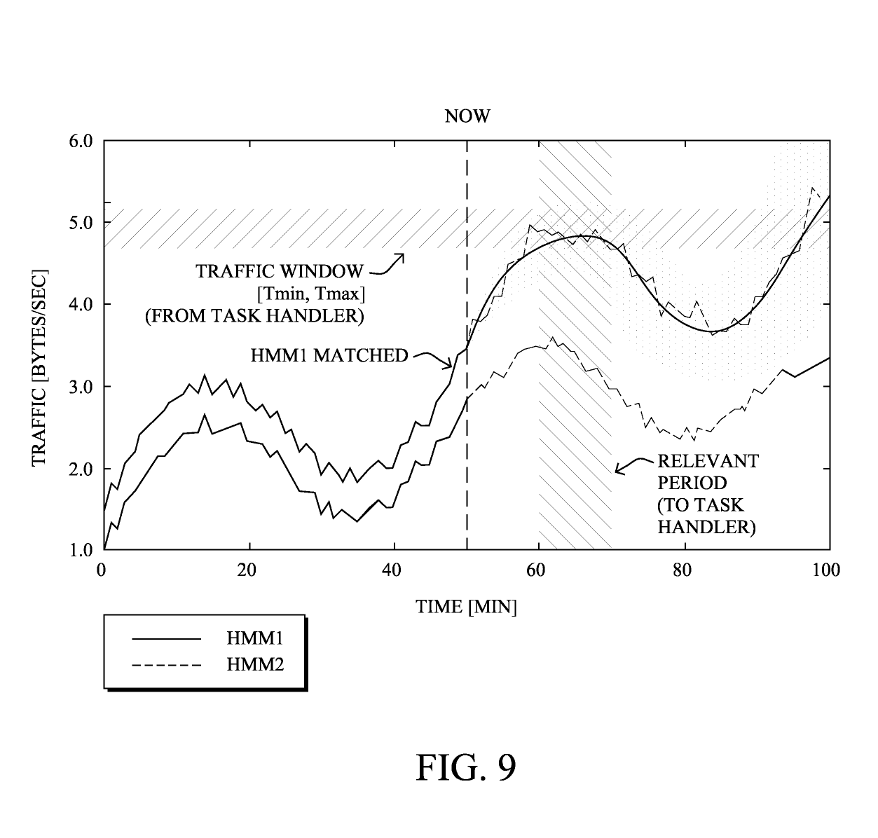

A third component of the techniques herein is the generic mechanism for predicting relevant periods (see FIG. 9). The traffic matching engine (second component above) may constantly evaluate input traffic data; assume that for the partial input sequence x_{1:k}=[x₁, . . . , xₖ], a given HMM Mᵢ has yielded the probability P(x_{1:k}|Mᵢ)>T. This means that the input traffic has matched the traffic profile corresponding to Mᵢ. Then, the latter can be used to extrapolate the most likely sequence of future values X_{k+1:n}. In particular, the techniques herein sample several realizations of the stochastic process x_{k+1:n}, thereby obtaining a statistically significant representation of the distributions P(xₖ₊₁), . . . , P(xₙ) (denoted by the labeled shaded area in FIG. 9). Based on this prediction, the prediction engine may now determine, in real time, the period of time during which certain traffic conditions are met. According to the architecture shown in FIG. 8, these traffic conditions are provided by a task handler, which may be co-located on the FAR, in the core, or in the datacenter. (The fourth component (below) will describe the message that is sent to the LM by the task handler for querying a relevant period.) If a relevant period is found, the LM transmits it to the task handler, which then proceeds with the task at the appropriate time. This mechanism offered by the FAR allows an application to perform a given task of interest (e.g., send a probe, start a firmware update, reboot a node, perform a shadow joining) if and only if the traffic conditions are appropriate. This is a particularly useful approach as there are currently no LM mechanisms that actively determine the state of utilization of the network and then in real-time deploy active techniques in the network.

As noted, the fourth component of the techniques herein is a newly defined message sent by the task handler to the LM (more specifically, the module responsible for computing the relevant periods). This message describes the traffic conditions that the task handler expects for executing its task. This message illustratively contains five fields: (1) the target node, (2) a traffic window [Tmin, Tmax] of minimal and maximal traffic, (3) the expected duration of the task, (4) the desired confidence of interval (i.e., how confident the HMM must be that the traffic for the target node will remain within [Tmin, Tmax] for the complete duration of the task), and (5) an expiration time (i.e., the latest time at which the FAR must have found a valid window for the task execution). Upon receiving this message, the LM will perform a traffic prediction for this particular node and try to find for a period of time that matches the requirements (i.e., minimal and maximal traffic, duration, and confidence). If it finds one such relevant period, it returns a success message to the task handler. Optionally, the task handler may re-evaluate its predictions at regular time intervals (since the LM predictions may have changed in light of new training data) for an improved accuracy. If the LM could not find any appropriate period, it will send a newly defined message notifying the task handler that the task cannot be scheduled. In another embodiment the FAR or other engine may decide to trigger further actions if the desired confidence is too low should the HMM require more training.

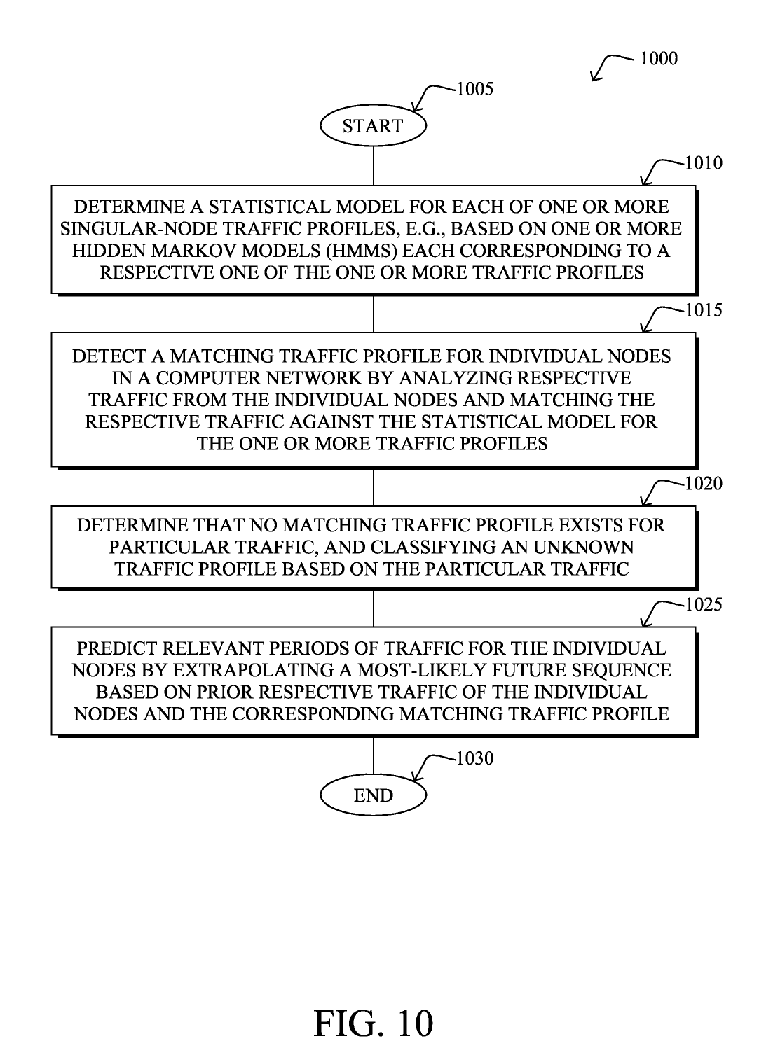

FIG. 10 illustrates an example simplified procedure 1000 for a Hidden Markov is Model based architecture to monitor network node activities and predict relevant periods in accordance with one or more embodiments described herein. The procedure 1000 may start at step 1005, and continues to step 1010, where, as described in greater detail above, a device (e.g., learning machine, FAR, etc.) determines a statistical model for each of one or more singular-node traffic profiles, such as based on one or more HMMs each corresponding to a respective one of the one or more traffic profiles as illustrated herein. For instance, as noted above, the one or more singular-node traffic profiles may be known a priori and configured on the device (i.e., the detecting and predicting device), such as being received from a central configuration device. Alternatively, the detecting and predicting device may individually determine the statistical model(s), accordingly. In particular, regardless of where the statistical models are created, observed variables of the one or more HMMs may be defined as multi-dimensional traffic data, where each dimension of the multi-dimensional traffic data corresponds to a different type of traffic, averaged on a given time interval. Illustratively, a granularity of traffic types may be selected to apply to the multi-dimensional traffic data for a given HMM of the one or more HMMs, and a length of the given time interval for a given HMM may be based on a pattern of interest, as described above. Lastly, as described above, a single HMM per corresponding traffic profile may be assigned to all nodes in the network, or else individual nodes may be grouped into groups, such that a respective individual HMM per corresponding traffic profile may be assigned to each group.

In step 1015, the device may attempt to detect a matching traffic profile for individual nodes in a computer network by analyzing respective traffic from the individual nodes and matching the respective traffic against the statistical model for the one or more traffic profiles, as detailed above. Note that in response to determining that no matching traffic profile exists for particular traffic in step 1020, the device may classify an unknown traffic profile based on the particular traffic.

In addition, in step 1025, the device may predict relevant periods of traffic for the individual nodes in a manner as described above, such as by extrapolating a most-likely future sequence based on prior respective traffic of the individual nodes and the corresponding matching traffic profile. Note that a relevant period may generally be is described as a time at which respective traffic of an individual node is expected to match the corresponding traffic profile—or—a time at which respective traffic of an individual node is expected to not match the corresponding traffic profile, as mentioned above. The simplified procedure 1000 illustratively ends in step 1030, though notably may continue to update statistical models, detect matching traffic profiles, and predict relevant periods, accordingly.

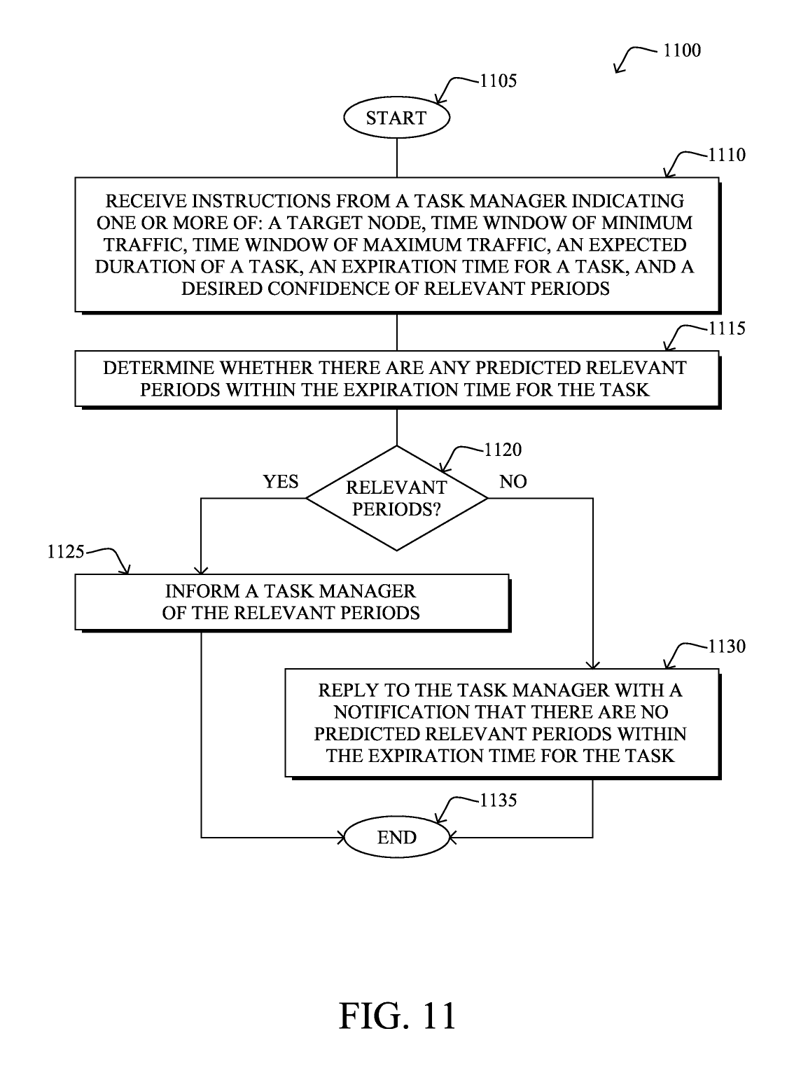

Additionally, FIG. 11 illustrates another example simplified procedure 1100 for a Hidden Markov Model based architecture to monitor network node activities and predict relevant periods in accordance with one or more embodiments described herein, which may operate in conjunction with procedure 1000 of FIG. 10. The procedure 1100 may start at step 1105, and continues to step 1110, where, as described in greater detail above, the device may first have received instructions from a task manager indicating one or more of: a target node, time window of minimum traffic, time window of maximum traffic, an expected duration of a task, an expiration time for a task, and/or a desired confidence of relevant periods. As such, in step 1115, the device may determine whether there are any predicted relevant periods according to the received instructions, particularly within the noted expiration time for the task, if provided. If there are relevant periods found in step 1120, then in step 1125 the device may inform a task manager of the relevant periods, accordingly. On the other hand, if there are no relevant periods found, then in step 1130 the device may reply to the task manager with a notification that there are no predicted relevant periods within the expiration time for the task. The illustrative procedure 1100 may then end in step 1135.

It should be noted that while certain steps within procedures 1000-1100 may be optional as described above, the steps shown in FIGS. 10-11 are merely examples for illustration, and certain other steps may be included or excluded as desired. Further, while a particular order of the steps is shown, this ordering is merely illustrative, and any suitable arrangement of the steps may be utilized without departing from the scope of the embodiments herein. Moreover, while procedures 1000-1100 are described separately, certain steps from each procedure may be incorporated into each other procedure, and the is procedures are not meant to be mutually exclusive.

The techniques described herein, therefore, provide for a Hidden Markov Model based architecture to monitor network node activities and predict relevant periods. In particular, the techniques herein, specifically HMMs, allow observed traffic profiles to be reinforced with what is expected. As such, traffic anomalies can be tracked and caught immediately (e.g., at the granularity of a per-node basis), where traffic anomalies can represent many things, such as security breaches, connectivity issues, application malfunction, and software glitches, to name a few. In LLNs, there are currently no such mechanisms to localize this kind of issue on a per-node basis. In addition, by tracking relevant periods in the network, active LM mechanisms can be intelligently deployed such that there is minimal impact in the functioning of the network. The techniques herein allow for more sophisticated requests to the FAR, for instance by asking it to perform firmware updates only when the nodes are expected to have little activity, or, conversely, to perform QoS probing only when the nodes are expected to generate a lot of traffic. This ability is critical in LLNs where the NMS cannot access all traffic data for architectural reasons (in particular, because of the low bandwidth between the NMS and the FAR) and where the user cannot make reasoned decisions regarding when to perform these tasks because of the sheer complexity of the underlying dynamics. Furthermore, the techniques herein rely on a statistical framework, which has the potential to be extended to fully Bayesian treatment, thereby allowing for automated parameter tuning, graceful performance degradation and recovery in case of changing conditions, and a principled handling of uncertainty and unpredictability of LLNs.

While there have been shown and described illustrative embodiments that provide for a Hidden Markov Model based architecture to monitor network node activities and predict relevant periods, it is to be understood that various other adaptations and modifications may be made within the spirit and scope of the embodiments herein. For example, the embodiments have been shown and described herein with relation to LLNs and related protocols. However, the embodiments in their broader sense are not as limited, and may, in fact, be used with other types of communication networks and/or protocols. In addition, while the embodiments have been shown and described with is relation to learning machines in the specific context of communication networks, certain techniques and/or certain aspects of the techniques may apply to learning machines in general without the need for relation to communication networks, as will be understood by those skilled in the art. Further, while the techniques herein generally relied upon HMMs to generate statistical models, other types of statistical models may be used in accordance with the techniques herein.

The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly this description is to be taken only by way of example and not to otherwise limit the scope of the embodiments herein. Therefore, it is the object of the appended claims to cover all such variations and modifications as come within the true spirit and scope of the embodiments herein.

What is claimed is:

1. A method, comprising:
determining a statistical model for each of one or more singular-node traffic profiles;
detecting a matching traffic profile for individual nodes in a computer network by analyzing respective traffic from the individual nodes and matching the respective traffic against the statistical model for the one or more traffic profiles; and
predicting relevant periods of traffic for the individual nodes by extrapolating a most-likely future sequence based on prior respective traffic of the individual nodes and the corresponding matching traffic profile.

2. The method as in claim 1, further comprising:
informing a task manager of the relevant periods.

3. The method as in claim 1, further comprising:
receiving instructions from a task manager indicating one or more of: a target node, time window of minimum traffic, time window of maximum traffic, an expected duration of a task, an expiration time for a task, and a desired confidence of relevant periods.

4. The method as in claim 3, further comprising:
determining that there are no predicted relevant periods within the expiration time for the task; and
replying to the task manager with a notification that there are no predicted relevant periods within the expiration time for the task.

5. The method as in claim 1, wherein a relevant period comprises one of either a time at which respective traffic of an individual node is expected to match the corresponding traffic profile or a time at which respective traffic of an individual node is expected to not match the corresponding traffic profile.

6. The method as in claim 1, wherein determining the statistical model for each of one or more singular-node traffic profiles is based on one or more Hidden Markov Models (HMMs) each corresponding to a respective one of the one or more traffic profiles.

7. The method as in claim 6, further comprising:
grouping individual nodes into groups; and
assigning a respective individual HMM per corresponding traffic profile to each group.

8. The method as in claim 6, further comprising:
assigning a single HMM per corresponding traffic profile to all nodes in the network.

9. The method as in claim 6, further comprising:
defining observed variables of the one or more HMMs as multi-dimensional traffic data, wherein each dimension of the multi-dimensional traffic data corresponds to a different type of traffic, averaged on a given time interval.

10. The method as in claim 9, further comprising:
selecting a granularity of traffic types to apply to the multi-dimensional traffic data for a given HMM of the one or more HMMs.

11. The method as in claim 9, wherein a length of the given time interval for a given HMM is based on a pattern of interest.

12. The method as in claim 1, further comprising:
determining that no matching traffic profile exists for particular traffic; and
classifying an unknown traffic profile based on the particular traffic.

13. The method as in claim 1, wherein the one or more singular-node traffic profiles are known a priori and configured on a detecting and predicting device.

14. An apparatus, comprising:
one or more network interfaces to communicate with a computer network;
a processor coupled to the network interfaces and adapted to execute one or more processes; and
a memory configured to store a process executable by the processor, the process when executed operable to:
determine a statistical model for each of one or more singular-node traffic profiles;
detect a matching traffic profile for individual nodes in the computer network by analyzing respective traffic from the individual nodes and matching the respective traffic against the statistical model for the one or more traffic profiles; and
predict relevant periods of traffic for the individual nodes by extrapolating a most-likely future sequence based on prior respective traffic of the individual nodes and the corresponding matching traffic profile.

15. The apparatus as in claim 14, wherein the process when executed is further operable to:
inform a task manager of the relevant periods.

16. The apparatus as in claim 14, wherein the process when executed is further operable to:
receive instructions from a task manager indicating one or more of: a target node, time window of minimum traffic, time window of maximum traffic, an expected duration of a task, an expiration time for a task, and a desired confidence of relevant periods.

17. The apparatus as in claim 16, wherein the process when executed is further operable to:
determine that there are no predicted relevant periods within the expiration time for the task; and
reply to the task manager with a notification that there are no predicted relevant periods within the expiration time for the task.

18. The apparatus as in claim 14, wherein determining the statistical model for each of one or more singular-node traffic profiles is based on one or more Hidden Markov Models (HMMs) each corresponding to a respective one of the one or more traffic profiles.

19. The apparatus as in claim 18, wherein the process when executed is further operable to:
group individual nodes into groups; and
assign a respective individual HMM per corresponding traffic profile to each group.

20. The apparatus as in claim 18, wherein the process when executed is further operable to:
assign a single HMM per corresponding traffic profile to all nodes in the network.

21. The apparatus as in claim 18, wherein the process when executed is further operable to:
define observed variables of the one or more HMMs as multi-dimensional traffic data, wherein each dimension of the multi-dimensional traffic data corresponds to a different type of traffic, averaged on a given time interval.

22. The apparatus as in claim 14, wherein the process when executed is further operable to:
determine that no matching traffic profile exists for particular traffic; and
classify an unknown traffic profile based on the particular traffic.

23. A tangible, non-transitory, computer-readable media having software encoded thereon, the software when executed by a processor operable to:
determine a statistical model for each of one or more singular-node traffic profiles;
detect a matching traffic profile for individual nodes in the computer network by analyzing respective traffic from the individual nodes and matching the respective traffic against the statistical model for the one or more traffic profiles; and
predict relevant periods of traffic for the individual nodes by extrapolating a most-likely future sequence based on prior respective traffic of the individual nodes and the corresponding matching traffic profile.

24. The computer-readable media as in claim 23, wherein determining the statistical model for each of one or more singular-node traffic profiles is based on one or more Hidden Markov Models (HMMs) each corresponding to a respective one of the one or more traffic profiles.
